(19) United States
(12) Patent Application Publication
(10) Pub. No.: US 2007/0283572 A1
(43) Pub. Date: Dec. 13, 2007

(54) Cutting tool attachment for vibrating tools

(76) Inventor: Albert Saiz, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/636,729

(22) Filed: Dec. 11, 2006

Related U.S. Application Data
(63) Continuation-in-part of application No. 11/448,358, filed on Jun. 7, 2006.

(51) Int. Cl. B26B 7/00

(52) U.S. Cl. 30/272.1; 30/314; 30/329

(57) ABSTRACT

A cutting tool attachment that attaches to a vibrating tool, such as a vibrating sander or the like, to convert the vibrating tool to a cutting tool for cutting asphalt composition shingles, carpet, drywall and other work materials. In a preferred embodiment, the cutting tool attachment comprises a bracket member that removably attaches to the base of a vibrating sander. A cutting blade, particularly one configured for the type of work material to be cut, removably attaches to the bracket member. In a preferred embodiment, an extension member interconnects the cutting blade and bracket member. The bracket member attaches by use of screws, sliding engagement with a plurality of side engaging members, clamping mechanisms and/or by use of a variety of other attaching mechanisms. Once attached, the vibrating tool vibrates the bracket member, which vibrates the cutting blade so as to cut the work material faster and with less effort.

### CROSS-REFERENCE TO RELATED APPLICATIONS

This patent application claims the benefit of U.S. patent application Ser. No. 11/448,358 filed Jun. 7, 2006.

### BACKGROUND OF THE INVENTION

A. Field of the Invention

The field of the present invention relates generally to tools utilized for cutting work materials, such as composition shingles, carpet and drywall. More particularly, the present invention relates to such cutting tools that are specifically configured to vibrate the cutting blade. Even more specifically, the present invention relates to a blade supporting attachment that attaches to a vibrating tool, such as a vibrating sander, to cut the work material.

B. Background

Various roofing materials are utilized as the outer, environmental barrier on roofs throughout the world. The most common type of roofing material utilized in the United States and Canada are asphalt-based shingles, which are commonly referred to as composition roofing shingles or composition shingles due to the combination of materials used for the shingles. The most common types of composition shingles comprise a tough reinforcing membrane or fabric, which is typically either a fiberglass-based mat or an organic felt, that is covered or impregnated with one or more layers of asphalt and/or asphalt mixtures. In some areas of the country, particularly those in hot and humid areas, zinc or copper granules are applied to the fiberglass mat or organic felt to protect against the growth of algae. Modified asphalt composition shingles utilize a rubber modifier, such as Styrene or Polypropylene based material, to enhance flexibility, durability, crack resistance, impact resistance and resistance to ultraviolet light. Historically, the most common type of a composition shingle has been the three-tab shingle. A more modern type of shingle, commonly referenced as architectural laminated shingles, is an asphalt composition shingle having a textured look designed to simulate wood, concrete or slate in order to provide a much less expensive alternative to the “real” material. Composition shingles were originally sold as having a 15 year life. Today, most composition shingles are marketed as having a minimum of a 20 year life, with some manufactures offering composition shingles having a 30 to 50 year estimated life, such as those sold under the Grand Sequoia® and Presidential® brands. One of the primary differences between the lower and longer life shingles is the thickness of the shingles, particularly with regard to the longest life shingles, which can have three layers of shingles combined together into one shingle.

During the installation of a roof having composition shingles it is necessary to cut the shingles to the size and shape necessary for the layout of the roof. The typical cutting tool for composition shingles is a hand-held utility knife, usually of the type having a retractable blade that extends from or retracts into the knife handle. Over the years, the knife utilized by roofers has evolved from the common straight edged blade utility knife to one having a hooked or notched shaped blade portion to better get under and cut through composition shingles. These speciality utility knives are commonly referred to as composition or roofers knives. One common configuration for composition knives utilizes a carbon hook utility blade having a pair of facing hook portions separated by a center mounting hole that allows the user to swap ends of the blade when one of the hook portions becomes dull due to use. Another common configuration is referred to as a bow-tie roofer blade, which has a pair of generally V-notched cutting sections at each end separated by the center mounting hole. Although they require manual application of sufficient force to cut through the composition shingles, both types of knives have worked generally well for many years. The main problem with composition knives is that the asphalt material in the composition shingles tends to bunch or clog up around the blade's hook or notch section, thereby making further cutting difficult. With the advent of the thicker, longer life composition shingles (i.e., those having an estimated useful life of 30 or more years), it has become even more difficult to cut the shingles with the standard, hand-held composition knife.

Over the years, various people have developed improved shingle cutting tools for cutting composition shingles. For instance, U.S. Pat. No. 2,914,851 to Rogers describes a shingle cutter that is configured as a pistol-grip type of device that has cutter blade which pivots between a pair of horizontal legs to cut a shingle when the user squeezes the grip member towards the handle. U.S. Pat. No. 4,821,609 to Rushbrook describes a shingle cutting tool having a cutting body, made from a flat plate made from hardened steel, that is attached to an elongated handle. The cutting body has a pair of opposite directed V-shaped notches having sharpened cutting edges. The notches face in opposite directions to allow the user to push or pull the tool across the shingles to cut them. U.S. Publication No. 2004/0128836 to Garrett describes a shingle cutting tool that is alternatively shown as a miniaturized reciprocating saw, a miniaturized circulating saw and a standard hook-configured composition knife adapted to receive compressed air to move the blade in a reciprocating motion. Although the reciprocating motion of the composition knife version of the Garrett reference appears to reduce the need for the user to pull the knife through the composition shingle, in reality the tool would likely have the same problem with regard to the asphalt material clogging the hook portion of the blade while the user attempts to pull or push the blade through the shingles. U.S. Publication No. 2005/0204652 to Schafer describes a shingle cutting device having one or more hooked cutting blades which are attached to a base section with a C-shaped channel that is configured to fit over and slidably engage an upwardly extending ridge on a roof to cut the section of the shingles in a roof valley.

Cutting knifes are also utilized to cut carpet, drywall and other work materials. Generally, these knifes are provided with cutting blades that are, at least to certain degree, specially configured to beneficially cut a specific type of work material and to attach to a specifically configured handle. The configuration of the blades and knife handles have evolved based on preferences of the users and the attributes of the materials to be cut. Other than the shape of the blade and/or the handle, these knifes generally function the same way they have for many years. Improvements to the cutting knifes for carpet, drywall and other work materials have been similar to that described above for knifes configured to cut composition shingles and the like, generally incorporating reciprocating knife blades or rotating knife blades. It has generally been perceived by those skilled in the art that the reciprocating and/or rotating motion of a cutting blade is easier to cut with than a stationary blade.

One of the most common types of tools utilized by both professionals and homeowners is a vibrating sander. The typical vibrating sander has a motor that drives a vibrating mechanism that vibrates the bottom surface of the sander, on which is placed a sheet of sandpaper or other abrasive paper for use to smooth or shape wood, metal, plastics or other materials. Vibrating sanders are typically operated by gripping the sander with one hand and place it in abutting relation to the material to be smooth such that the abrasive paper on the bottom moves in a vibratory mode against the material to be smoothed or shaped. Most vibrating sanders are provided with a clamping mechanism on the bottom that is utilized to engage the ends or sides of the abrasive paper to removably hold it against the bottom surface of the sander. When the abrasive paper becomes excessively worn, the user unclamps the paper from the sander and replaces it with a new sheet of abrasive paper.

None of the foregoing prior art devices is much of an improvement over the results achieved with the standard composition knife with regard to being able to more easily and quickly cut composition shingles, particularly the thicker composition shingles. With regard to other work materials such as carpet and drywall, the various tools that are available or been offered as improvements to the standard cutting knife used for the specific material, are generally not as commonly utilized or accepted as the standard knife itself. What is needed, therefore, is an improved cutting tool for cutting composition shingles, carpet, drywall and other work materials. The preferred cutting tool should be configured to more easily and quickly cut through composition roofing shingles, even the more modern thicker shingles, and other work materials with minimum effort exerted by the user. Preferably, the improved cutting tool would be configured to be a hand-held tool that utilizes cutting blades of the type that are currently available. The preferred cutting tool should be configured by combining a cutting tool attachment with a vibrating tool, such as a vibrating sander, that is adapted to be powered by air supplied through an air hose or by electrical power, whether attached to a cord or cordless.

### SUMMARY OF THE INVENTION

The cutting tool attachment for vibrating tools of the present invention solves the problems and provides the benefits identified above. That is to say, the present invention discloses an attachment that removably attaches to a vibrating tool, such as a vibrating sander, to provide a cutting tool which more easily and quickly cuts through composition shingles, carpet, drywall and other work materials than the commonly utilized cutting knife and the other prior art cutting tools. In the preferred embodiment, the improved shingle cutting tool of the present invention attaches to a powered vibrating sander, such as those powered by air or electrical, including the cord and cordless types, to vibrate the cutting blade so as to facilitate cutting through composition shingles and other work materials with a minimum amount of physical cutting effort by the user. The preferred cutting tool attachment of the present invention is sized and configured to removably attach to the base of a vibrating sander or other vibrating tool and utilize standard, replaceable hook, notched or other specially configured cutting blades. For cutting composition shingles, the cutting tool preferably utilizes a rotatable, double-sided cutting blade that allows the user to quickly change the use of the cutting tool from one that is pulled through the composition shingle during cutting to one that is pushed through the shingle during cutting.

In one general aspect of the present invention, the cutting tool attachment for vibrating tools comprises a tool housing that includes a handle section and a head section, a cutting blade that is attached to the tool housing, the cutting blade having one or more cutting edges, and a vibrating mechanism that is associated with the tool housing for vibrating the cutting blade so as to more easily and quickly cut composition shingles to their desired size and configuration. In the preferred embodiment, the cutting blade has at least two cutting edges and it is pivotally attached to a head body in the head section so as to allow the user to selectively place the cutting blade in position for cutting in a rearward/pulling direction or a forward/pushing direction. Preferably, the head section is separate from but attached to one end of an elongated handle that comprises the handle section so as to reduce the amount of vibration where the tool is held by the user when cutting composition shingles. If desired, a dampening member can be disposed between the head and handle sections to further reduce vibration at the handle. In alternative embodiments, the head and handle sections are integral and the vibrating mechanism is disposed in the integral component or the vibrating mechanism is disposed in the separate handle section. The vibrating mechanism can comprise a pneumatically powered motor with a pneumatic connector provided to connect to a pneumatic line. An air regulating control valve can be utilized to allow the user to regulate the flow of air to the motor so as to control the amount of vibration. In an alternative embodiment, the vibrating mechanism comprises an electric motor that is either powered by batteries disposed in the handle section or by a cord that connects to an outlet or other source of electrical power. In the preferred configuration, the cutting tool is configured to be a relatively small, hand-held device that can be quickly deployed to cut composition shingles when needed or desired. Standard hook blades or bow-tie blades can be utilized with the cutting tool. In use, the cutting blade is locked into its desired position, the vibrating mechanism is activated, the user places the cutting edge against the composition shingles at the place where he or she desires to cut it and then the user directs the cutting blade along the cutting path. The vibration of the cutting blade will make it much easier and faster for the user to cut the shingles.

In the cutting tool attachment embodiment of the present invention, the cutting tool attachment is utilized to convert, generally temporarily, a vibrating tool to a cutting tool similar to that described above. In one embodiment of this invention, the vibrating tool is a vibrating sander having a base with a vibrating bottom surface. The cutting tool attachment is configured to engage the vibrating tool such that the vibration thereof during its operation will vibrate the cutting blade component of the cutting tool attachment. In a preferred embodiment, the cutting tool attachment comprises a bracket member configured to engage the vibrating tool, a mechanism for removably attaching the bracket member to the vibrating tool, an extension member extending outwardly from the bracket member and a cutting blade removably secured at or near the outward end of the extension member. The cutting blade, having one or more cutting edges, can be of the type that is specially configured for cutting composition shingles, carpet, drywall or a variety of other work materials. The mechanism for removably attaching the bracket member to the vibrating tool can comprise one or more connectors, such as machine screws or the like, that are configured to pass through the bracket member and secure it in abutting relation to the vibrating surface of the vibrating tool. Alternatively, the mechanism can comprise two spaced apart side engaging members on the bracket member that are sized and configured to slidably engage a portion, such as the base, of the vibrating tool therebetween so the user can slide the cutting tool attachment on and off the vibrating tool. In another alternative embodiment, one or more of the side engaging members is configured with a spring-loaded clamping mechanism that allows the user to clamp the side engaging member against the vibrating tool. In yet another embodiment, bracket member can also include a front side engaging member and/or a back side engaging member, with one or more of the various side engaging members being attached to the bracket member with an adjusting mechanism that allows the user to adjust the cutting tool attachment for different lengths and widths of vibrating tools. In the preferred embodiments, the user can easily and quickly convert a vibrating tool to a cutting tool when he or she desires to cut a work material and then remove the cutting tool attachment when it is desired to use the vibrating tool for its original purpose.

Accordingly, the primary objective of the present invention is to provide a cutting tool attachment for vibrating mechanisms that is useful for cutting composition shingles, carpet, drywall and other work materials that provides the advantages discussed above and overcomes the disadvantages and limitations associated with presently available material cutting tools.

It is also an important object of the present invention to provide a cutting tool attachment for composition shingles and other work materials that removably attaches to a vibrating sander or other vibrating tool to vibrate the cutting blade so as to more easily and quickly cut the work material with less cutting effort exerted by the user.

It is also an important object of the present invention to provide a cutting tool attachment for vibrating sanders and like tools that is adaptable to being configured for a wide variety of different sizes and configurations of such tools, including those vibrating tools that are air or electrically powered, to vibrate a cutting blade as it moves through shingles or other work materials so as to substantially reduce the amount of physical force required from the user.

It is also an important object of the present invention to provide a cutting tool attachment that is removably attached to a vibrating tool, such as a vibrating sander or the like, so the user may easily switch between using the vibrating tool for its intended use, such as sanding, and to vibrate a cutting blade to cut shingles, carpet, drywall or other work materials.

It is also an object of the present invention to provide a cutting tool attachment for vibrating tools that utilizes commonly available cutting blades, including those that are specially configured for specific work materials such as composition shingles, carpet and drywall.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is side view of a cutting tool for cutting composition shingles configured according to a preferred cutting tool embodiment of the present invention showing the head portion attached to the handle, the cutting blade configured for pulling the tool through the composition shingles and the tool configured for attachment to a supply of compressed air;

FIG. 2 is a side view of the cutting tool for composition shingles of FIG. 1 showing use of batteries to supply power to the vibrating mechanism and the cutting blade configured for pushing the tool through the composition shingles;

FIG. 3 is a side view of the cutting tool of FIG. 2 showing use of an electric cord to supply power to the vibrating mechanism;

FIG. 4 is a side view of an alternative embodiment of the cutting tool for composition shingles of the present invention showing the vibrating mechanism incorporated into a vibrating housing so as to vibrate the notched cutting blade;

FIG. 5 is a side view of the head section showing the components of the vibrating mechanism disposed therein;

FIG. 6 is a side view of a cutting tool attachment configured according to a preferred attachment embodiment shown attached to the bottom surface of a vibrating sander, with a composition shingle blade mounted on the cutting tool attachment, to define a cutting tool for cutting composition shingles;

FIG. 7 is an exploded side view of the cutting tool of FIG. 6 showing the use of screws to attach the cutting tool attachment to the vibrating sander;

FIG. 8 is a top perspective view of the cutting tool attachment of the present invention shown in FIGS. 6 and 7;

FIG. 9 is a top perspective view of the cutting tool attachment of FIG. 8 with the cutting blade removed therefrom;

FIG. 10 is a side view of alternative cutting blades which can be utilized with cutting tool attachment of the present invention;

FIG. 11 is a side view of an alternative configuration for the cutting tool attachment of the present invention that is attached to a vibrating sander using a pair of spaced apart side members on the cutting tool attachment and shown cutting a work material;

FIG. 12 is a back view of the cutting tool attachment and vibrating sander of FIG. 11;

FIG. 13 is a top plan view of the cutting tool attachment and vibrating sander of FIG. 11;

FIG. 14 is a top perspective view of the cutting tool attachment of FIG. 11; and

FIG. 15 is an alternative configuration of the cutting tool attachment of the present invention showing use of a spring-loaded side bracket member, an adjustable position back bracket member and a fixed front bracket member.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are directed to a hand-held tool, those skilled in the art will readily understand that this is merely for purposes of simplifying the present disclosure and that the present invention is not so limited, as the present invention is equally applicable for use with a tool mounted on a long handle or another apparatus.

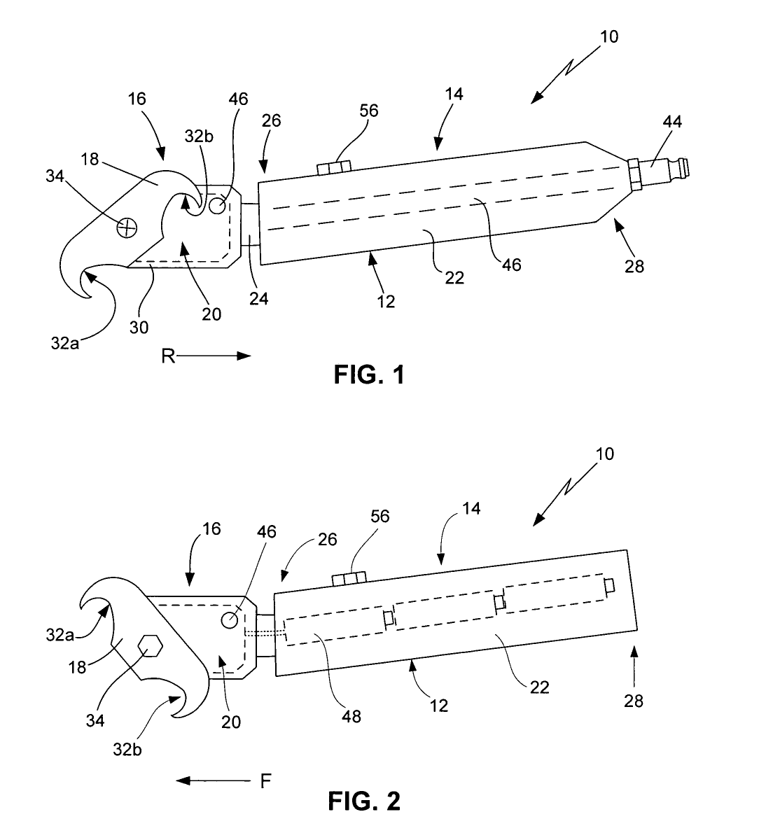

A cutting tool that is manufactured out of the components and configured pursuant to a preferred embodiment of the present invention is shown generally as 10 in the figures. Cutting tool 10 generally comprises a tool housing 12 having a handle section 14 and a head section 16, a cutting blade 18 and a vibrating mechanism 20 associated with the tool housing 12 for imparting a vibration motion to cutting blade 18. In the preferred configuration, shown in FIGS. 1 through 3, handle section 14 and head section 16 are separate components that are joined together with the vibrating mechanism 20 disposed inside head section 16. In an alternative embodiment, shown in FIG. 4, handle section 14 and head section 16 are integral such that tool housing 12 is a unitary housing member with vibrating mechanism 20 disposed inside tool housing 12. The primary benefit of having handle section 14 separate from, but connected to, head section 16 is to reduce the vibration at elongated handle 22, which is the part of cutting tool 10 held by the user during use. In other embodiments, vibrating mechanism 20 can be disposed inside handle section 14 or attached externally to the outer surface of tool housing 12 (i.e., disposed inside a separate housing component). As explained in more detail below, vibrating mechanism 20 is configured to impart vibration to cutting blade 18 so as to cut composite shingles faster and easier than with prior art shingle cutting tools. Because the vibration of cutting blade 18 must be of sufficient intensity to assist cutting blade 18 cutting through the asphalt composite shingles, the user of cutting tool 10 will likely feel some of that vibration at the point where his or her hand holds onto cutting tool 10 at handle 22. Separating the head section 16, which in the preferred embodiment encloses or houses vibrating mechanism 20, will reduce the vibrations felt by the user. If desired, a vibration damping member 24 can be utilized to interconnect handle section 14 and head section 16 so as to further reduce the vibration felt by the user as he holds onto handle 22.

In the preferred embodiment, handle section 14 comprises a hand grippable, tubular handle 22 having a first end 26 and a second end 28 and head section 16 comprises a head body 30 configured with an internal chamber in which is positioned vibrating mechanism 20. As set forth in the embodiments shown in the figures, head body 30 of head section 16 connects to or is integral with the first end 26 of handle 22. For ease of use, it is preferred that the overall length of cutting tool 10 be approximately eight to ten inches and that handle 22 have a generally circular cross-section with a diameter of approximately one to three inches. As will be readily apparent to those skilled in the art, however, the invention is not so limited, as the cutting tool 10 can be of any size suitable for use to cut composite shingles and the cross-section of handle 22 can be square, rectangle, hexagon, octagon or various other shapes. Handle 22 and head body 30 can be manufactured from a variety of materials, including metal, plastics and suitable composites. The materials for cutting tool 10 should be selected with the knowledge that cutting tool 10 will be used by those in the roofing industry under somewhat difficult situations. As such, the materials for handle 22 and head body 30 should be as lightweight as possible yet durable, corrosion resistant and generally impact resistant. In addition, because the user of cutting tool 10 will usually be cutting roofing materials laying on a flat surface, it is preferred that the centerline of handle 22 be somewhat at an angle relative to a plane extending along the bottom of head body 30 (as shown in the figures), below which cutting blade 18 extends, for ease of cutting purposes. In a preferred configuration, this angle is approximately 20 to 30 degrees. With this configuration, the user will not have to tilt cutting tool 10 during use to cut composite shingles.

The cutting blade 18 of the embodiment shown in the figures is attached to the outer surface of head body 30 such that the cutting edge 32 of cutting blade 18 extends outwardly of head body 30 to cut the asphalt shingles. Although cutting blade 18 can have a single cutting edge 32, in the preferred embodiment, cutting blade 18 has two or more cutting edges, shown as 32a and 32b in FIGS. 1 and 32a, 32b, 32c and 32d in FIG. 4 (collectively the cutting edges are referred to as cutting edge 32) for rearward cutting (i.e., pulling cutting tool 10 toward the user in the direction indicated as “R” on FIG. 1) or forward cutting (i.e., pushing the cutting tool 10 away from the user in the direction indicated as “F” on FIG. 2). As known in to those skilled in the art, some people in the roofing industry prefer to pull the composition knife or other prior art cutting device through the composition shingles and others prefer to push the knife to cut the shingles at the desired location. In the configuration shown in FIG. 1, with cutting edge 32a shown extending downward from head body 30, the cutting tool 10 is ready for rearward R or pulling use, whereas in the configuration shown in FIG. 2 the cutting edge 32b is for forward F or pushing use. In a preferred embodiment, shown in FIGS. 1 through 3, cutting edges 32a and 32b will be of the hooked type, such as the carbon hook utility blades from Irwin Industrial Tool Company (i.e., item number 2087100) or the large hook blade from Stanley Tools (i.e., product number 11-983). In an alternative embodiment, shown in FIG. 4, cutting blade 18 is of the notched, bow-tie type available from American Safety Razor Co. (i.e., model number MM0970-34). Although shown with the hook blade and the bow-tie blade in FIGS. 1 through 4, the invention is not so limited. As will be readily apparent to those skilled in the art, a straight edge blade or other configurations of cutting blade 18 can also be utilized with cutting tool 10 of the present invention to cut asphalt shingles. Preferably, which ever configuration of cutting blade 18 is utilized, the blade will preferably be of sufficient size to extend below head section 16 far enough to cut even the modern thicker composite shingles.

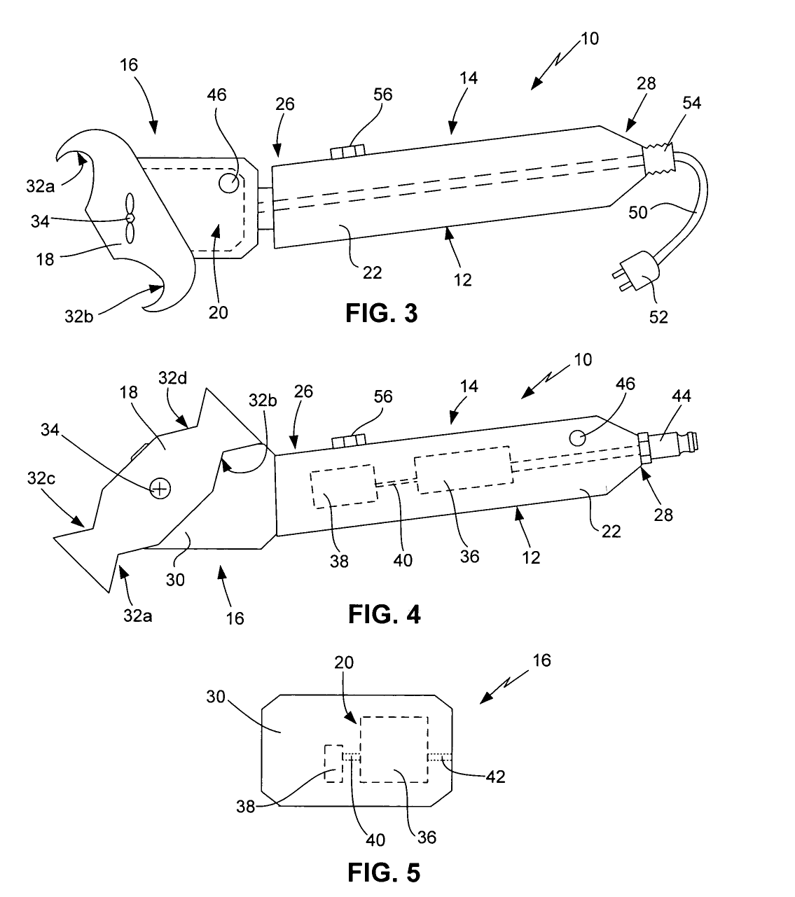

To facilitate the user selectively switching between the rearward R use of FIG. 1 and the forward F use of FIG. 2, it is preferred that cutting blade 18 be pivotally attached to head body 30 of head section 16. Preferably, cutting blade 18 is pivotally attached to head body 30 in a manner that allows the user to easily and quickly configure the cutting tool 10 for either rearward R or forward F cutting of the asphalt composite shingles. The head section 16 includes a connecting mechanism, shown as 34 in the figures, that connects the cutting blade 18 to head body 30 and securely holds it in position during use. Although the force required to be exerted by the user when utilizing cutting tool 10 will be somewhat less than with prior art devices, the connecting mechanism 34 must be able to effectively lock cutting blade 18 in the desired cutting position so as to prevent undesirable pivoting of cutting blade 18 during use. In the embodiments shown in FIGS. 1 and 2, the connecting mechanism is a phillips style screw. The embodiment shown in FIG. 2 utilizes a standard hexagon nut and the embodiment of FIG. 3 utilizes a wing nut. The connecting mechanisms shown in these figures are merely intended to be exemplary of the different types of connecting means 34 that can be utilized for cutting tool 10 of the present invention. Numerous other types of connecting mechanisms 34, including some which may be more or less difficult and quick to operate than those shown, can also be utilized to allow the user to selectively pivot cutting blade 18.

In the various figures of the preferred embodiments of the cutting tool 10 of the present invention, cutting blade 18 is removably attached to the outside of head body 30 by one or more connecting mechanisms 34. Alternatively, though not shown in the figures, those skilled in the art will readily understand and appreciate that head body 30 can be configured such that cutting blade 18 is received in or through head body 30, such as in a channel, cavity or other location on head body 30, and be clamped or otherwise be securable in a non-moving manner. As with current box cutter types of composition knives, cutting tool 10 can be configured with cutting blade 18 being retractable such that it is received inside head body 30 when not in use. Although not shown, those skilled in the art will know that head section 16 can include an internal sliding mechanism having an external thumb or finger guide to direct the cutting blade 18 between the exposed, locked cutting position and the retracted, stored position. The key requirement with regard to the placement of cutting blade 18 on or in head body 30 is that the cutting edge 32 of cutting blade extend outward of head body 30 during use to cut the shingles and that cutting blade 18 be in or be suitable for secure, non-moving attachment to head body 30 during use so as to effectively cut the asphalt composition shingles and reduce the likelihood of injury to the user of cutting tool 10. Another key requirement for cutting blade 18 is that it be relatively easily removed from cutting tool 18 for replacement when it becomes worn or damaged during use. In the preferred embodiment, as set forth above, cutting blade 18 should be able to pivot relative to head body 30 so as to allow the user to pivot or rotate the cutting edges 34.

The key improvement of cutting tool 10 of the present invention is the use of vibrating mechanism 20 to assist with the cutting of asphalt composition shingles by cutting blade 18. The present inventor has been in the roofing business for many years and has seen significant changes with regard to the composition shingles used for roofing. As set forth above, the materials utilized for composition shingles have changed and the shingles have gotten much thicker and, therefore, much harder to cut with the standard composition knife. Due to the difficulty of cutting the modern, thicker composition shingles, the inventor attempted to find an easier way to cut the composition shingles, but had little success until he developed the cutting tool 10 of the present invention with the vibrating mechanism 20. Identifying the benefit to cutting composite shingles by the addition of vibration to the cutting blade 18 significantly improved the ease and speed at which the shingles are cut, a result not expected by the inventor or by those skilled in the art of hand tools for roofing materials. The improvement in cutting shingles from the cutting tool 10 of the present invention applies to straight cuts and non-straight (i.e., curved or circular) cuts that are necessary to lay the shingles around roof projections and curved roof lines. The amount of vibration necessary to obtain the improvement of the present invention does not have to be significant. The inventor has found that the vibration imparted by other vibrating tools, such as a hand sander, is sufficient to vibrate the cutting blade 18 and improve the cutting of asphalt composition shingles.

As stated above, in the preferred embodiment of cutting tool 10 the vibrating mechanism 20 is disposed inside head body 30 of head section 16. Alternatively, as shown in FIG. 4, vibrating mechanism 20 can be incorporated into handle 22 of handle section 14. The use of vibration mechanism 20 to impart a vibration to a tool component is well known in the art and is commonly utilized in conjunction with other tools, most notably portable vibrating sanders, and with other non-construction devices, including muscle relaxing vibrators and back scratchers. Numerous configurations for vibrating mechanism 20 are suitable for use with cutting tool 10 of the present invention. As best shown in FIG. 5, such vibrating mechanisms 20 generally comprise a motor 36 that turns an eccentric weight 38 and a shaft 40 that interconnects the motor 36 and eccentric weight 38. As set forth in more detail below, a tubular channel or wire 42 connects to a source of power for motor 36. As the motor 36 rotates shaft 40 with eccentric weight 38 attached thereto, the imbalanced nature of rotating eccentric weight 38 will impart a vibratory force to cutting tool 10, preferably primarily just the head section 16, to vibrate cutting blade 18 and obtain the ease of cutting for the present invention.

Although various types of motors 36 may be suitable for use with cutting tool 10, the preferred motors 36 are of the pneumatic or electrical type due to the present use of such power sources in the roofing industry. Because many roofers currently utilize a pneumatic nail driving tool, it may be preferred to utilize a pneumatic motor 36 for cutting tool 10, as shown in FIGS. 1 and 4. In this manner, the compressed air supply line can connect to a Y connector at the user to divide the air line out to the currently used pneumatic nailer and to connect to a pneumatic connector 44 on the cutting tool 10 of the present invention. As shown in FIG. 1, pneumatic connector 44 can be located at the second end 28 of handle 22 with a pneumatic line or channel 46 inside handle 44 to connect to tube 42 and motor 36 so as to deliver compressed air to a rotor having air actuated blades or vanes. In the embodiment shown in FIG. 4, with motor 36 disposed inside the integral tool housing 12, the extra pneumatic line 46 may not be necessary. In either embodiment, it may be preferred to provide cutting tool 10 with an air regulating control mechanism 46 operatively connected to motor 36 so as to regulate the flow of compressed air to motor 36 in order to reduce or increase the vibration at cutting blade 18 so the user can have a smoother handling tool 10 or be able to cut thicker composition shingles. Control mechanism 46 is shown on head body 30 in FIG. 1 and on handle 22 in FIG. 4 so as to be more closely associated with motor 36.

In an alternative embodiment, motor 10 can be electric and powered by one or more rechargeable batteries 48, shown in FIG. 2, or a power cord 50, shown in FIG. 3, electrically connected to electric motor 36. Preferably, batteries 48 are of the rechargeable type so that the user can have a cordless cutting tool 10 that merely has to be recharged during non-use, as is common for many other tools in the roofing industry, as well as the construction industry in general. If batteries 48 are utilized for cutting tool 10, then it is preferred that the second end 28 of handle 22 be configured to be opened, either by unscrewing a cap at the end 28 or removing a door-like member so as to allow the user to remove batteries 48 from handle 22 for replacement as may be needed. If the electric motor 36 has power supplied through power cord 50, having a plug 52 at its distal end for plugging into a source of electricity (i.e., wall outlet or compressor), then batteries 48 become optional or even unnecessary. Preferably, the second end 28 of handle 22 in the embodiment of FIG. 3 is provided with a cord support member 54, commonly utilized with corded power tools, to prevent flexing of the power cord 50 resulting in damage to tool 10 or power cord 50.

In either the pneumatic or electric motor 36 embodiments, cutting tool 10 is preferably provided with an on/off switch 56 operatively connected to motor 36 to allow the user more control over the operation of cutting tool 10. The on/off switch 56 can be of the type that stays on when switch 56 is moved to the on position or it can be of the type that requires the user to maintain sufficient force against the switch 56 to keep it in the on position, so as to immediately shut off motor 36 when the force is released as a safety consideration, or a switch 56 can be a combination of the two. In the preferred embodiment, on/off switch 56 is located on handle 22 so that the user's thumb may easily reach it during use of cutting tool 10. Also in the preferred embodiment, handle 22 is covered with a rubber or like material to provide improved gripping, both from a comfort and a safety standpoint, of cutting tool 10 during use. Although handle 22 may be provided in a generally smooth configuration as shown in the figures, it may be preferred to provide a coarser surface and/or finger grips for even more improved gripping of cutting tool 10.

In use, the user selects whether he or she desires to have cutting blade 18 pivoted to the rearward R cutting direction or to the forward F cutting direction, as shown in FIGS. 1 and 2, respectively, and then connects cutting tool 10 to a source of pneumatic or electric power, as may be necessary. If provided, the cutting blade 18 is moved from its stored, retracted position to its operating, extended position. With cutting tool 10 connected to power and cutting blade 18 pivoted to the desired position, and locked into place on head section 16, the user then moves the on/off switch 56 to the “on” position so as to activate the pneumatic or electric motor 36 of the preferred embodiment of cutting tool 10 of the present invention. As a result of motor 36 rotating eccentric weight 38 via shaft 40 of vibrating mechanism 20, a vibration force will be imparted to cutting blade 28. The user then moves cutting blade 18 across the position on the composition shingle where he or she desires to make the cut with the cutting edge 32 against the composition shingle. The vibration of cutting blade 18 from vibration mechanism 20 will significantly reduce the amount of force that must be asserted by the user against the composition shingle, thereby easing and speeding up the cutting process. Once the user has cut the desired section of composition shingle, he or she moves the on/off switch to the “off” position and removes the cutting blade 18 from the composition shingle. If so provided, the user retracts the cutting blade into the head section 16 so as to prevent unintentional contact with cutting edge 32.

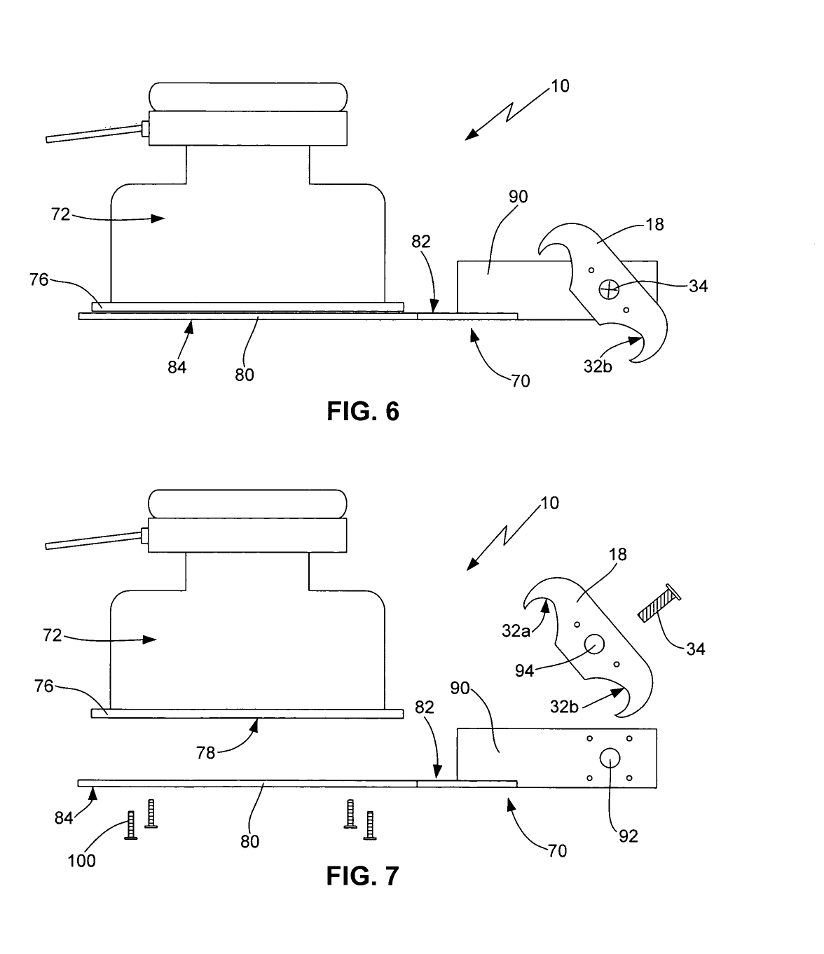

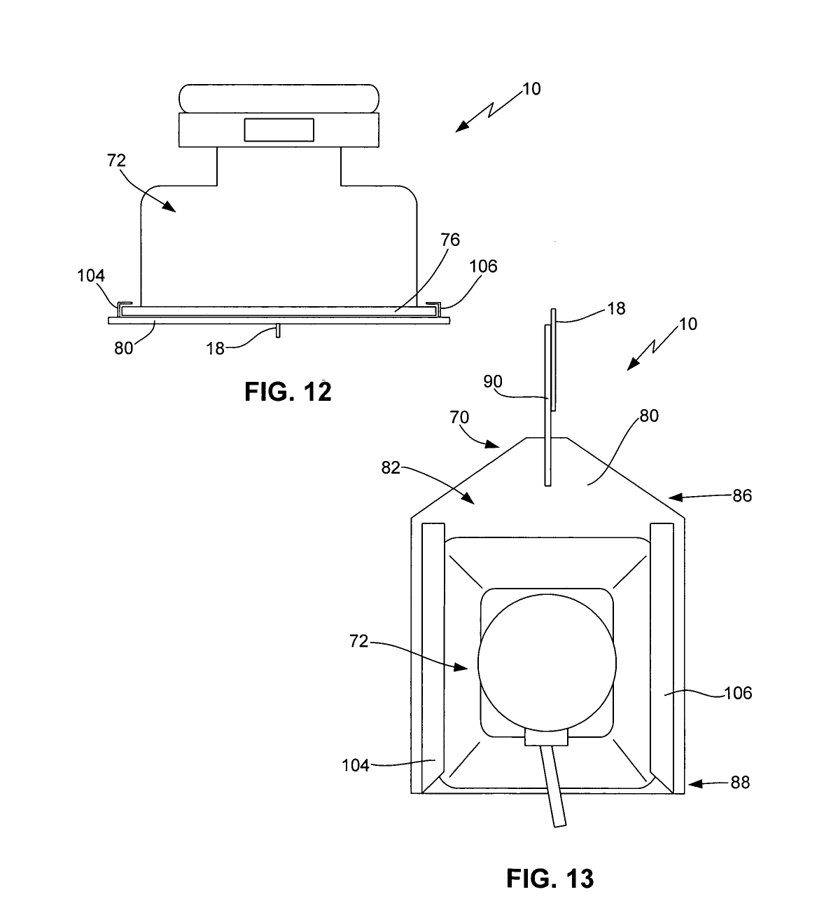

In an alternative embodiment of the present invention, cutting tool 10 is defined by attaching, preferably both removably and securely, a cutting tool attachment, shown as 70 in FIGS. 6 through 15, to a vibrating tool 72, such as the vibrating sander shown in the FIGS. 6-7 and 11-13, to cut a work material 74 (shown in FIG. 11) such as composition shingles, carpet or drywall. As described in more detail below, cutting tool attachment 70 can attach to vibrating tool 72 in various different ways to achieve the objectives of the present invention, such as utilizing screws, brackets, clamping mechanism or magnets to attach cutting tool attachment 70 to vibrating tool 72. Alternatively, cutting tool attachment 70 may be inserted into a slot or cavity located in vibrating tool 72. In the preferred embodiments, cutting tool attachment 70 is removably attached to vibrating tool 72 so the user may switch between utilizing the vibrating tool 72 for its original purposes (i.e., sanding and shaping) or as a cutting tool 10 by attaching cutting tool attachment 70 thereto. In the preferred embodiment, the various removable attaching means described below are sufficiently secured to vibrating tool 72 that it is able to cut through the work material 74 easily, quickly and safely.

As best shown in FIG. 7, the typical vibrating sander 72 has a base 76 that is vibrated by a motor and cooperatively configured vibrating mechanism, such as an eccentric weight, to vibrate sandpaper placed in abutting relation with the vibrating surface 78 of base 76, which is generally its bottom surface. As well known by those familiar with vibrating sanders 72 and like vibrating tools, the bottom surface 78 of base 76 can be a variety of different sizes and shapes. Although a rectangular configuration is perhaps the most common shape, vibrating sanders 72 are also available in other shapes, including square, circular and triangular. The cutting tool attachment 70 of the present invention can be shaped and configured to correspond to the shape of the base 76 and/or bottom surface 78 of vibrating sander 72. In addition, as set forth below, the means for attaching the cutting tool attachment 70 onto base 76 and/or bottom surface 78 can vary to accommodate the type or configuration of vibrating sander 72 or other vibrating tool to be utilized in conjunction with cutting tool attachment 70 of the present invention. Preferably, cutting tool attachment 70 is configured for use with existing vibrating sanders 72 with little or no modifications required to the base 76 and/or bottom surface 78 of vibrating sander 72.

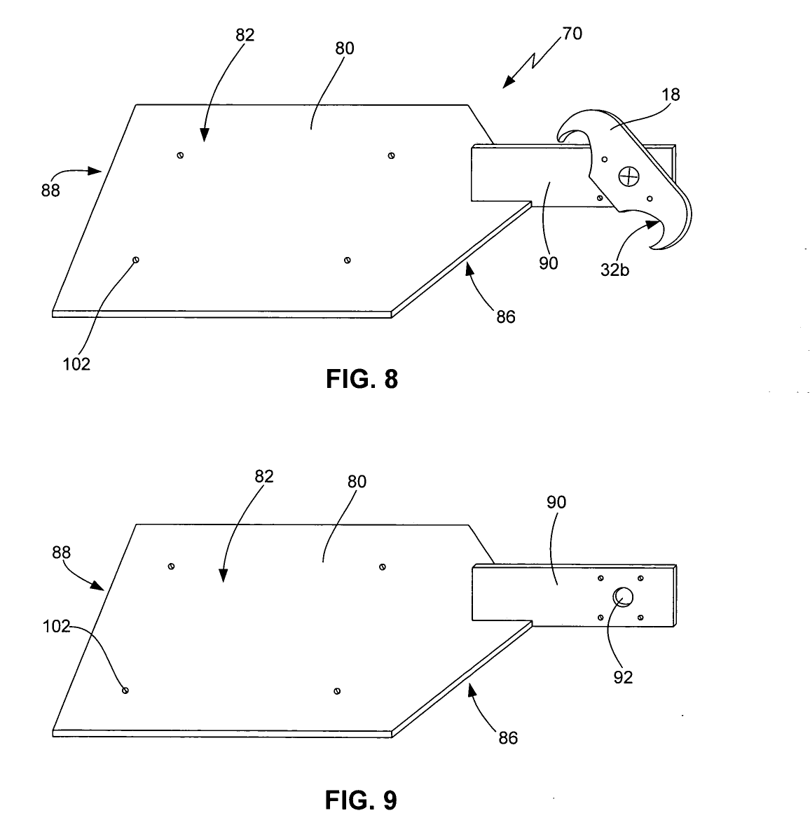

In the various embodiments shown, cutting tool attachment 70 comprises a bracket member 80, best shown in FIGS. 8, 9, 14 and 15, configured to securely attach to vibrating sander 72 by one or more of the attaching means set forth below. In the embodiments shown, bracket member 80 has a generally planar upper surface 82 configured to abut the typically planar bottom surface 78 of vibrating sander 72 and a generally planar lower surface 84 to allow the user to slide bracket member 80 along work material 74 during use. The embodiment shown in these figures is particularly configured for a vibrating sander 72 having a generally rectangular shaped bottom surface 78. Cutting tool attachment 70 is attached to vibrating sander 72 such that the first end 86 of bracket member 80 is positioned generally at or near the front or forward end of vibrating sander 72 and its second end 88 is positioned generally at or near the rear or rearward end of vibrating sander 72 during use. Cutting blade 18 is attached to, preferably removably, first end 86 of bracket member 80 in a manner that allows the user to selectively pull the cutting blade 18 through work material 74, as shown in FIG. 11, or push cutting blade 18 through the work material 74 to cut at the desired location. In the embodiments shown, the first end 86 of bracket member 80 is provided with a reduced width section to ease use of vibrating sander 72 when utilized as cutting tool 10.

If desired the first end 86 of bracket member 80 can be configured to receive cutting blade 18 directly on bracket member 80. Cutting blade 18 must be attached to bracket member 80 such that at least a portion of one of the cutting edges 32, such as cutting edge 32b, extends below the plane of lower surface 84 of bracket member 80 during use so that cutting blade 18 may cut work material 74, as best shown in FIG. 11. Various configurations and/or mechanisms can be utilized to attach cutting blade 18 to bracket member 80, including configurations which allow the user to raise and lower cutting blade 18 out of or into the cutting position (i.e., extending below bracket member 80) as desired by the user. For ease of attaching cutting blade 18 to bracket member 80 and providing the necessary positioning of cutting edge 32 relative to the lower surface 84 thereof, the embodiments shown in the figures illustrate use of an extension member 90 at the first end 86 of bracket member 80 that extends outwardly therefrom to interconnect bracket member 80 with cutting blade 18. As known to those skilled in the art, extension member 90 can be provided as a separate component that is attached to bracket member 80 by welding, adhesives or other mechanisms appropriate for the materials used for cutting tool attachment 70. Alternatively, extension member 90 can be made integral with bracket member 80.

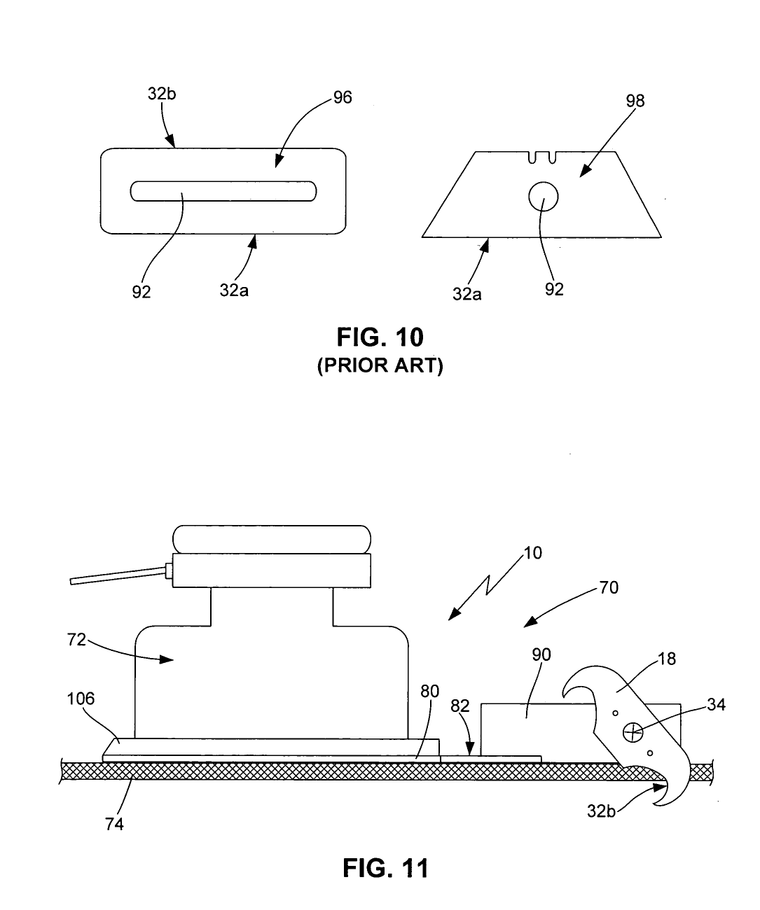

In the embodiments shown, extension member 90 is provided with an extension aperture 92 that is configured to receive connecting mechanism 34. In one embodiment, extension aperture 92 is a threaded aperture configured to receive a machine screw 34, which is also received through blade aperture 94, to secure cutting blade 18 to extension member 90, as best shown in FIG. 7. The configuration of a blade securing means to secure cutting blade 18 to either extension member 90 or bracket member 80 should be chosen to such that it secures cutting blade 18 in a manner that does not allow much flexing or other movement of cutting blade 18 during use. Preferably, such means is chosen to allow the user to relatively easily remove cutting blade 18 from bracket 80 or extension member 90 so that he or she may replace it as needed (i.e., due to wear or change in use) and then secure a replacement cutting blade 18 thereto. Preferably, any such apertures or other mechanisms for attaching cutting blade 18 is also configured to securely attach other types of cutting blades, such as the carpet blade 96 and the drywall blade 98 shown in FIG. 10. Depending on the mechanism for attaching the blades 18, 96 or 98, each should be provided with blade aperture 94 configured for use with connecting mechanism 34. In an alternative embodiment, the blade securing means includes a snap-on lock mechanism that allows the user to easily and quickly attach or remove cutting blade 18 from bracket member 80 or extension member 90. Cutting blade 18 can be provided with a plastic jacket or the like around its non-cutting edge that can be utilized with the blade securing means.

In the embodiment shown in FIGS. 6-9, cutting tool attachment 70 is configured to utilize one or more connectors, such as machine screws 100, as the attaching means to securely attach bracket member to the bottom surface 78 of vibrating sander 72. To facilitate the use of machine screws 100 as the attaching mechanism, bracket member 80 is provided with one or more securing apertures 102 that are configured to receive machine screws 100 therethrough so as to allow the user to removably attach bracket member 80 to the bottom surface 78 of vibrating sander 72 so as to place the components in generally an abutting relation. In one embodiment, best shown in FIGS. 8 and 9, the pattern for securing apertures 102 is selected to match a specific pattern of threaded holes, not shown, on the bottom surface 78 of vibrating sander 72 to secure bracket member 80 thereto. In an alternative embodiment, bracket member 80 is provided with a plurality of securing apertures 102 that are spaced thereon to allow a single bracket member 80 be received on a variety of hole patterns on the bottom surfaces 78 of different vibrating sanders 72 so as to provide an essentially “universal” bracket member 80. In order maintain smooth contact between cutting tool 10 and work material 74, preferably the area around securing apertures 102 on the lower surface 84 is recessed or otherwise set back such that the head portion of machine screws 100 do not extend below the plane of the lower surface 84.

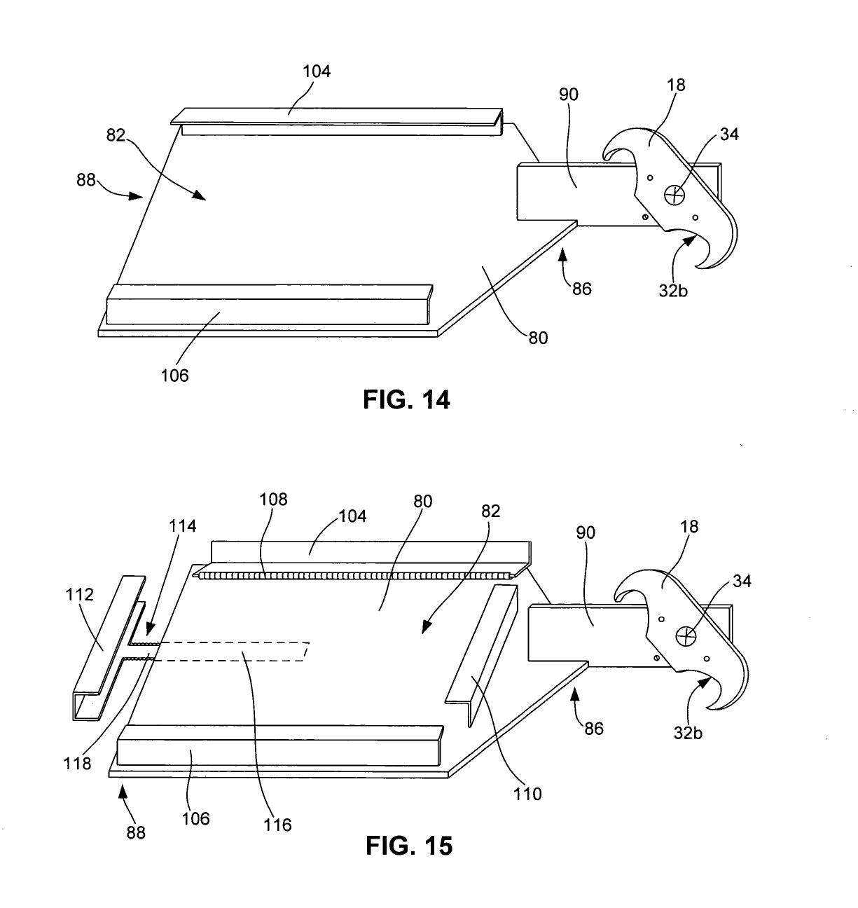

A second embodiment of the cutting tool attachment 70 of the present invention is shown in FIG. 14 and shown attached to vibrating sander 72 in FIGS. 11 through 13. In this embodiment, cutting tool attachment 70 is configured to slide onto the sides of base 76 of vibrating sander 72. As best shown in FIG. 14, bracket member 80 is provided with two spaced apart side engaging members as the attachment means, such as first side engaging member 104 and second side engaging member 106, configured to allow base 76 to slide therebetween so as to place upper surface 82 of bracket member 80 in abutting or near abutting relationship with the vibrating surface 78 (i.e., its bottom surface) of vibrating sander 72. In the preferred configuration of this embodiment, first 104 and second 106 side engaging members are L-shaped members with the downward portions spaced apart slightly more than the width of bracket member 80 such that cutting tool attachment 70 tightly slides onto base 76 to secure bracket member 80 thereto. Preferably, the inward portions of the L-shaped first 104 and second 106 side engaging members are spaced apart from the upper surface 82 of bracket member 80 an amount slightly greater than the thickness of base 76 such that the side engaging members 104/106 also engage the upper portion of base 76 to assist in securing bracket member 80 on vibrating sander 72. The width and height of side engaging members 104/106 and their cross-sectional configuration will depend on the configuration of base 76 of vibrating sander 72. It is preferred that the engagement between first 104 and second 106 side engaging members is sufficiently tight to prevent cutting tool attachment 70 from wobbling or otherwise moving during use of the cutting tool 10 to cut through work material 74. As with the previous embodiment, it is also preferred that both the upper 82 and lower 84 surfaces of bracket member 80 be substantially planar to ease the engagement with vibrating sander 72 and allow cutting tool attachment 70 to smoothly slide over work material 74.

To better facilitate engaging and disengaging cutting tool attachment 70 from vibrating sander 72, one or more the side engaging members 104/106 can be configured with a means for clamping the side engaging member(s) onto base 76. In the embodiment shown in FIG. 15, first side engaging member 104 is provided with a spring-loaded hinge 108, such as a piano-type hinge or the like, that allows the user to fold first side engaging member 104 away from bracket member 80, as shown, for ease of placement on base 76 and then spring close it against base 76 to secure cutting tool attachment 70 onto vibrating sander 72. With the clamping means 108, the cutting tool attachment 70 can be more easily removed from base 76 by folding first side engaging member 104 away from vibrating sander 72 and then sliding bracket member 80 off base 76. Other types of spring-loaded mechanisms than that shown in FIG. 15 can also be utilized for clamping means 108. In addition, although FIG. 15 only shows cutting tool attachment 70 with clamping means 108 at first side engaging member 104, those skilled in the art will readily appreciate that second side engaging member 106 can also have clamping means 108 or have it instead of first side engaging member 104.

As also shown in FIG. 15, cutting tool attachment 70 can also be provided with a front side engaging member 110 and a back side engaging member 112. As with the side engaging members 104/106, front side 110 and back side 112 engaging members should be sized and configured to engage base 76 so as to assist in securing cutting tool attachment 70 to vibrating sander 72. In the configuration shown in FIG. 15, front side engaging member 110 is configured in the same L-shape as side engaging members 104/106 and fixed in position near the first end 86 of bracket member 80. Back side engaging member 112, located at or near the second end 88 of bracket member 80, is provided with an adjusting mechanism 114 for adjusting the position of back side engaging member 112 relative to bracket member 80, or the distance between back side engaging member 112 and front side engaging member 110, for different lengths of vibrating sanders 72. In the embodiment shown in FIG. 15, adjusting mechanism 114 is of the type that slides in and out of a chamber 116 located in bracket member 80 such that the sides of an adjusting rod 118 engage the side walls of chamber 116. As will be readily apparent to those skilled in the art, a variety of adjusting mechanisms 114 can be utilized with cutting tool attachment 70 of the present invention. In addition, one or more of the other side walls 104, 106 and 110 can also (or instead) be provided with an adjusting mechanism 114 to allow those members to move in and out relative to bracket member 80 so the user can adjust the size thereof for different sizes of vibrating sanders 72 and/or bases 76.

In addition to the foregoing, a variety of other attachment means can be utilized with the cutting tool attachment 70 of the present invention. For instance, depending on the materials utilized for base 76 and bracket member 80, the embodiment of FIGS. 8 and 9 can be provided with one or more strong magnets on the upper surface 82 of bracket member 80 that are configured to securely attach bracket member 80 to bottom surface 78 of base 76. Although this configuration would be easier to install and remove than machine screws 100, the magnets would have to be strong enough to prevent any significant movement of cutting tool attachment 70 during use of cutting tool 10. In an alternative to this embodiment, vibrating sander 72 can be provided with an electromagnet that is selectively engaged to securely attach bracket member 80 to the bottom surface 78 of base 76. In yet another embodiment, vibrating sander 72 can be provided with a slot-like cavity in which bracket member 80 is inserted, typically from its second end 88, in an engaging manner in the cavity to securely engage cutting tool attachment 70 with vibrating sander 72. In yet another embodiment, cutting tool attachment 70 and vibrating sander 72 can be cooperatively configured such that bracket member 80 can be clasped by the clamps that are normally utilized to hold the sandpaper against bottom surface 78 of base. In this manner, the user would engage or disengage cutting tool attachment in the same way he or she adds or removes the sandpaper from the vibrating sander 72. Various other configurations for the attaching means to attach cutting tool attachment 70 to vibrating sander 72 or other vibrating tools are also available so as to provide an easy to use but secure mechanism for effectively converting the vibrating tool 72 to a cutting tool 10.

When the user desires to cut work material 74, such as composition shingles, carpet or drywall, he or she can convert a standard vibrating tool, such as vibrating sander 72, to a cutting tool 10 by attaching cutting tool attachment 70 thereto. Depending on the attaching means utilized, whether connectors (i.e., machine screws or the like), side engaging members, clamping mechanisms or others, the user securely attaches bracket member 80 to the vibrating tool. For vibrating sander 72 as the tool, the user attaches cutting tool attachment 70 to the base 76 thereof. The attaching means should be such that the vibrating surface 78, or bottom surface of vibrating sander 72, will transmit its vibration to bracket member 80 and then to cutting blade 18 (depending on the work material, 74 blades 96 or 98 are utilized). The user then utilizes this work tool 10 in the manner described above to cut the work material 74 at the desired location. The vibration of cutting blade 18 will significantly ease the cutting of the work material, thereby reducing time to cut the material and the amount of effort required by the user. When the user is done cutting the material, he or she can utilize vibrating sander 72 in its normal manner by removing cutting tool attachment 70.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A cutting tool attachment for use in combination with a vibrating tool having a vibrating surface to cut a work material, said cutting tool attachment comprising:
a bracket member configured to engage said vibrating tool;
means for attaching said bracket member to said vibrating tool; and
a cutting blade attached to said bracket, said cutting blade having one or more cutting edges configured to cut said work material,
wherein when said bracket is attached to said vibrating tool said vibrating tool vibrates said cutting blade so as to facilitate cutting said work material.

2. The cutting tool attachment according to claim 1, wherein said bracket member is shaped and configured to engage said vibrating surface and be vibrated thereby.

3. The cutting tool attachment according to claim 1, wherein said bracket member is removably attached to said vibrating tool.

4. The cutting tool attachment according to claim 1, wherein cutting blade is removably attached to said bracket.

5. The cutting tool attachment according to claim 1 further comprising an extension member extending outwardly from said bracket member and interconnecting said cutting blade and said bracket member.

6. The cutting tool attachment according to claim 5, wherein said extension member is attached to a first end of said bracket member and said cutting blade is removably attached to said extension member.

7. The cutting tool attachment according to claim 1, wherein said attaching means is configured to place an upper surface of said bracket member in abutting relation with said bottom surface of vibrating tool.

8. The cutting tool attachment according to claim 7, wherein said vibrating tool is a vibrating sander having a base with said vibrating surface on said base, said vibrating surface is substantially planar, said upper surface of said bracket member is substantially planar and said attaching means is configured to place said bracket member in abutting relation with said vibrating surface.

9. The cutting tool attachment according to claim 1, wherein said attaching means comprises one or more connectors configured to engage said vibrating tool.

10. The cutting tool attachment according to claim 1, wherein said attaching means comprises one or more side engaging members on said bracket member, said one or more side engaging members configured to engage said vibrating tool to secure said bracket member thereto.

11. The cutting tool attachment according to claim 10, wherein said attaching means comprises a first side engaging member and a second side engaging member on said bracket member, said first side engaging member and said second side engaging member in spaced apart relation to each other and configured to slidably engage said vibrating tool.

12. The cutting tool attachment according to claim 10, wherein at least one of said side engaging members comprises means interconnecting said side engaging member and said bracket member for clamping said side engaging member to said vibrating tool.

13. The cutting tool attachment according to claim 10, wherein at least one of said side engaging members comprises means interconnecting said side engaging member and said bracket member for adjusting the position of said side engaging member relative to said bracket member to secure said bracket member to said vibrating tool.

14. A cutting tool attachment for use in combination with a vibrating tool having a base with a vibrating surface to cut a work material, said cutting tool attachment comprising:
a bracket member configured to engage said base of said vibrating tool;
an extension member attached to said bracket member and extending outwardly therefrom;
means for removably attaching said bracket member to said base of said vibrating tool; and
a cutting blade removably attached to said extension member, said cutting blade having one or more cutting edges configured to cut said work material,
wherein when said bracket is attached to said base of said vibrating tool said vibrating tool vibrates said cutting blade so as to facilitate cutting said work material.

15. The cutting tool attachment according to claim 14, wherein said attaching means comprises one or more connectors configured to engage said base.

16. The cutting tool attachment according to claim 14, wherein said attaching means comprises one or more side engaging members on said bracket member, said one or more side engaging members configured to engage said base to secure said bracket member to said vibrating tool.

17. The cutting tool attachment according to claim 16, wherein said attaching means comprises a first side engaging member and a second side engaging member on said bracket member, said first side engaging member and said second side engaging member in spaced apart relation to each other and configured to slidably engage said base of said vibrating tool.

18. The cutting tool attachment according to claim 16, wherein at least one of said side engaging members comprises means interconnecting said side engaging member and said bracket member for clamping said side engaging member to said base of said vibrating tool.

19. The cutting tool attachment according to claim 16, wherein at least one of said side engaging members comprises means interconnecting said side engaging member and said bracket member for adjusting the position of said side engaging member relative to said bracket member to secure said bracket member to said base of said vibrating tool.

20. A cutting tool attachment for use in combination with a vibrating sander having a base with a vibrating surface thereon to cut a work material, said cutting tool attachment comprising:
a bracket member configured to engage said base of said vibrating sander;
a first side engaging member on said bracket member;
a second side engaging member on said bracket member in spaced apart relation to said first side engaging member, each of said first side engaging member and said second side engaging member configured to slidably engage said base; and
a cutting blade removably attached to said extension member, said cutting blade having one or more cutting edges configured to cut said work material,
wherein when said bracket is attached to said base of said vibrating sander said vibrating sander vibrates said cutting blade so as to facilitate cutting said work material.
